(19) United States
(12) Patent Application Publication
(10) Pub. No.: US 2026/0057300 A1
(43) Pub. Date: Feb. 26, 2026

(54) METHODS, SYSTEMS, AND MEDIA FOR GENERATING CUSTOM MODELS USING A MULTIMEDIA UNDERSTANDING MODEL

(71) Applicant: Integral Ad Science, Inc., New York, NY (US)

(72) Inventors: Arnaud de Froissard de Broissia, Paris (FR); Quentin Yivan Huang, Paris (FR); Andres Ospina Trivino, Paris (FR); Victor Rambaud, Paris (FR); Laurine Burgard-Lotz, Paris (FR); Paulo Roberto de Oliveira da Costa, Dublin (IE); Ravi Yadav, Dublin (IE); Clement Collet, Paris (FR); Maxence Vanhonnacker, Paris (FR); Pierre Fribourg, Paris (FR); Karen Anello, Philadelphia, PA (US); Kumaresh Singh, Livingston, NJ (US)

(21) Appl. No.: 19/306,307

(22) Filed: Aug. 21, 2025

Related U.S. Application Data
(60) Provisional application No. 63/685,458, filed on Aug. 21, 2024.

(51) Int. Cl. G06N 20/00

(52) U.S. Cl. CPC G06N 20/00

(57) ABSTRACT

Methods, systems, and media for generating one or more custom models, such as artificial intelligence models or machine learning models, using a multimedia understanding model. More particularly, the multimedia understanding model can be a large foundational model that is trained using image data, video data, audio data, text data, and/or page data extracted from multiple content items, where the multimedia understanding model can generate, for a given content item, a unified embedding for use with one or more machine learning models (e.g., a classification server executing a classification model that classifies the content of the content item, such as a video content item, into each of twelve defined risk categories) and/or applications (e.g., an application that generates groups of content items that represent daily trends, a search engine application that provides matching content items based on text inputs, image inputs, audio inputs, video inputs, etc., a classification application that generates new or additional categories for classifying the content of a content item, etc.).

### CROSS-REFERENCE TO RELATED APPLICATION

This application claims the benefit of U.S. Patent Application No. 63/685,458, filed Aug. 21, 2024, which is hereby incorporated by reference herein in its entirety.

### TECHNICAL FIELD

The disclosed subject matter relates to generating one or more custom models, such as artificial intelligence models or machine learning models, using a multimedia understanding model. More particularly, the multimedia understanding model can be a large foundational model that is trained using image data, video data, audio data, text data, and/or page data extracted from multiple content items, where the multimedia understanding model can generate, for a given content item, a unified embedding for use with one or more machine learning models (e.g., a classification server executing a classification model that classifies the content of the content item, such as a video content item, into specifically defined risk categories) and/or applications (e.g., an application that generates groups of content items that represent daily trends, a search engine application that provides matching content items based on text inputs, image inputs, audio inputs, video inputs, etc., a classification application that generates new or additional categories for classifying the content of a content item, etc.).

### BACKGROUND

Advertisers often choose where and how to deploy advertisements based on the relevance of the advertisement to a target audience. In online advertising marketplaces, advertisers are often disconnected from the exact content (e.g., webpage, video, social media posts, etc.) which appear in the same context as the advertisement. Brand safety is therefore a frequent concern for these advertisers.

The emergence of social media networks and platforms centered around video sharing and editing (e.g., Instagram, Snapchat, TikTok, Twitch, etc.) highlights the need for a brand safety solution that performs video analysis across content from diverse sources. Current video classification approaches, however, tend to rely on frame-by-frame image analysis of the shared video alone, while neglecting other aspects of the video. Moreover, there are a number of classification challenges, where new classification categories may only apply to new content items and where the development, evaluation, and release of a new classification category is often a long and tedious process. In addition, such classification approaches require a large quantity of handcrafted logic.

Accordingly, it is desirable to provide methods, systems, and media that overcome these and other deficiencies in the prior art.

### SUMMARY

Methods, systems, and media for generating custom models using a multimedia understanding model are provided.

In accordance with some embodiments of the disclosed subject matter, a method for generating custom models is provided, the method comprising: receiving, from a computing device, a content item that contains at least one of text data, image data, video data, audio data, and page data; extracting the text data, the image data, the video data, the audio data, and the page data from the content item; inputting the text data, the image data, the video data, the audio data, and the page data from the content item extracted from the content item into a multimedia understanding model that has been trained from a plurality of content items each having at least one of text data, image data, video data, audio data, and page data, wherein the multimedia understanding model generates a unified embedding having a plurality of values that each represent a component of the text data, the image data, the video data, the audio data, and the page data associated with the content item; and applying the unified embedding to one of a plurality of machine learning models.

In some embodiments, the unified embedding further comprises a plurality of first values that each correspond to portions of the text data, a plurality of second values that each correspond to portions of the image data, a plurality of third values that each correspond to portions of the video data, a plurality of fourth values that each correspond to portions of the audio data, and a plurality of fifth values that each correspond to portions of the page data.

In some embodiments, the content item is trend data associated with a particular time period and the unified embedding associated with the trend data is applied to a classification learning model that generates groups of content items that each include a plurality of content items having an embedding that is similar to the unified embedding corresponding to the trend data.

In some embodiments, the content item is a search query and the unified embedding associated with the search query is applied to a search engine application that generates one or more search query results of content items having an embedding within a vector database that is similar to the unified embedding corresponding to the search query. In some embodiments, the one or more search query results comprise one of: a matching video content item, a matching image content item, a matching audio content item, a matching textual content item, and a matching page content item.

In some embodiments, the unified embedding associated with the content item is applied to a classification learning model that determines whether to generate a new category for classifying content items. In some embodiments, the new category is added to a plurality of existing risk categories.

In some embodiments, the unified embedding associated with the content item is applied to an adaptation model that determines contextual information associated with the content item, wherein the contextual information associated with the content item and a large language model embedding generated based on received textual inquiry submitted to a chatbot application are inputted into a large language model to determine a response to the received textual inquiry.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 shows an illustrative example of a process for generating one or more custom models, such as artificial intelligence models or machine learning models, or custom applications using a multimedia understanding model in accordance with some embodiments of the disclosed subject matter.

FIG. 2 shows an illustrative example of a process for generating a unified embedding that represents the components of a content item using a multimedia understanding model in accordance with some embodiments of the disclosed subject matter.

FIG. 3 shows an illustrative example of a process for transmitting a unified embedding that represents the components of a content item using a multimedia understanding model to one or more machine learning models and/or one or more applications in accordance with some embodiments of the disclosed subject matter.

FIG. 4 shows an illustrative example of a process for transmitting a unified embedding that represents the components of a search query that includes text data, image data, video data, audio data, or page data using a multimedia understanding model to a search engine application that includes a vector database for determining one or more search results that have similar embeddings in comparison with the unified embedding in accordance with some embodiments of the disclosed subject matter.

FIG. 5 shows an illustrative example of a process for generating a unified embedding that represents the components of a content item that can include text data, image data, video data, audio data, and/or page data using a multimedia understanding model, where contextual information determined from the unified embedding associated with the content item and a large language model embedding corresponding to a text inquiry received through a chatbot interface are transmitted to a large language model to answer the text inquiry received through the chatbot interface in connection with the content item, in accordance with some embodiments of the disclosed subject matter.

FIG. 6 is an example block diagram of a system that can be used to implement mechanisms described herein in accordance with some embodiments of the disclosed subject matter.

FIG. 7 is an example block diagram of hardware that can be used in a server and/or a user device of FIG. 6 in accordance with some embodiments of the disclosed subject matter.

### DETAILED DESCRIPTION

In accordance with some embodiments of the disclosed subject matter, mechanisms (which can include methods, systems, and media) for generating one or more custom models, such as artificial intelligence models or machine learning models, using a multimedia understanding model. More particularly, the multimedia understanding model can be a large foundational model that is trained using image data, video data, audio data, text data, and/or page data extracted from multiple content items, where the multimedia understanding model can generate, for a given content item, a unified embedding for use with one or more machine learning models (e.g., a classification server executing a classification model that classifies the content of the content item, such as a video content item, into specifically defined risk categories) and/or applications (e.g., an application that generates groups of content items that represent daily trends, a search engine application that provides matching content items based on text inputs, image inputs, audio inputs, video inputs, etc., a classification application that generates new or additional categories for classifying the content of a content item, etc.).

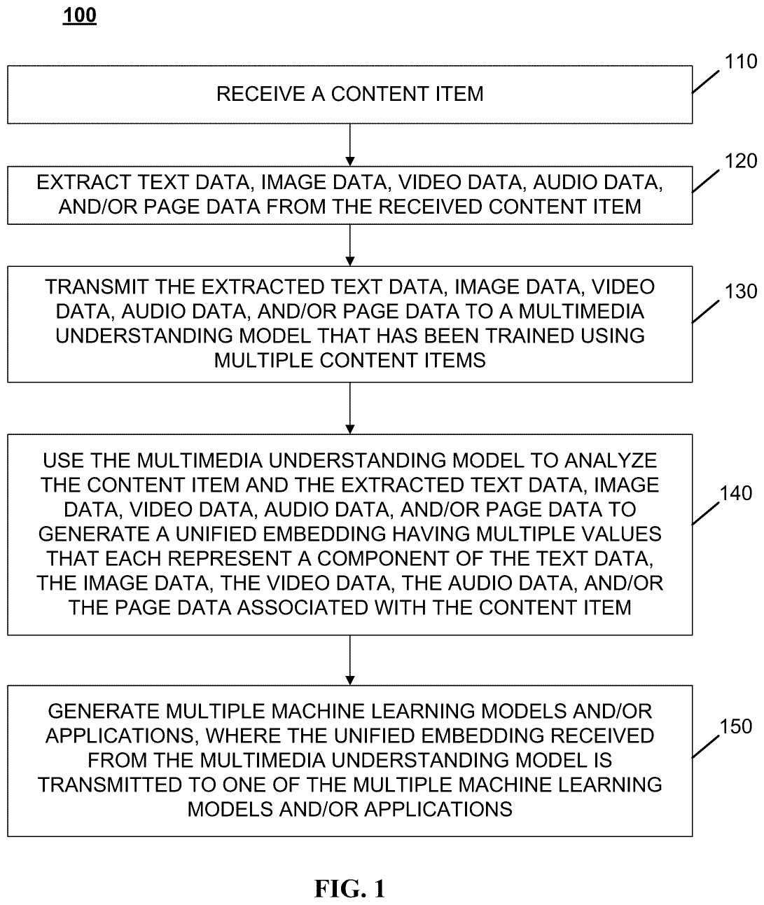

These and other features for generating one or more custom models, such as artificial intelligence models or machine learning models, using a multimedia understanding model are described further in connection with FIGS. 1-7.

Turning to FIG. 1, an illustrative example of a process 100 for generating one or more custom models, such as artificial intelligence models or machine learning models, using a multimedia understanding model in accordance with some embodiments is shown. In some embodiments, process 100 can be wholly or partially performed by a coordination server 602, one or more analysis servers 603, 604, and 605, and/or a classification server 608.

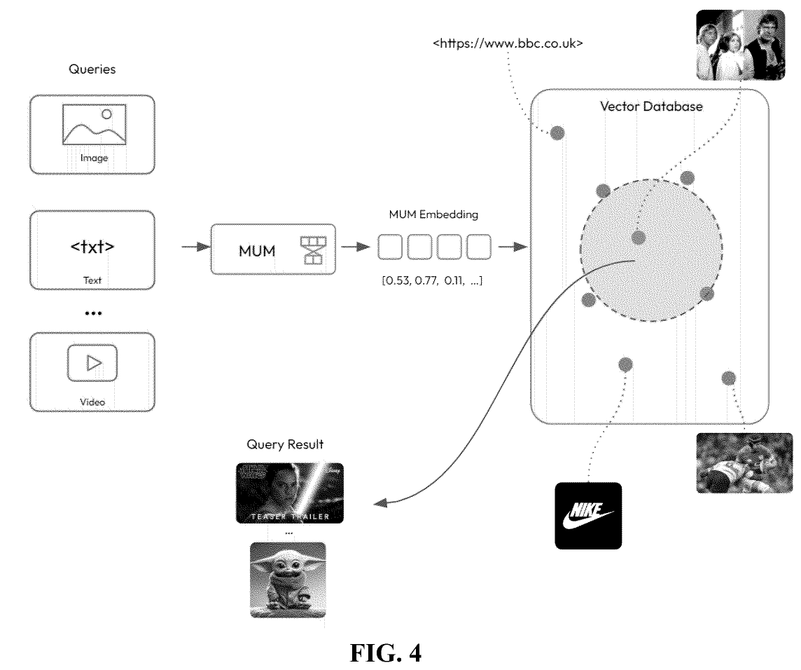

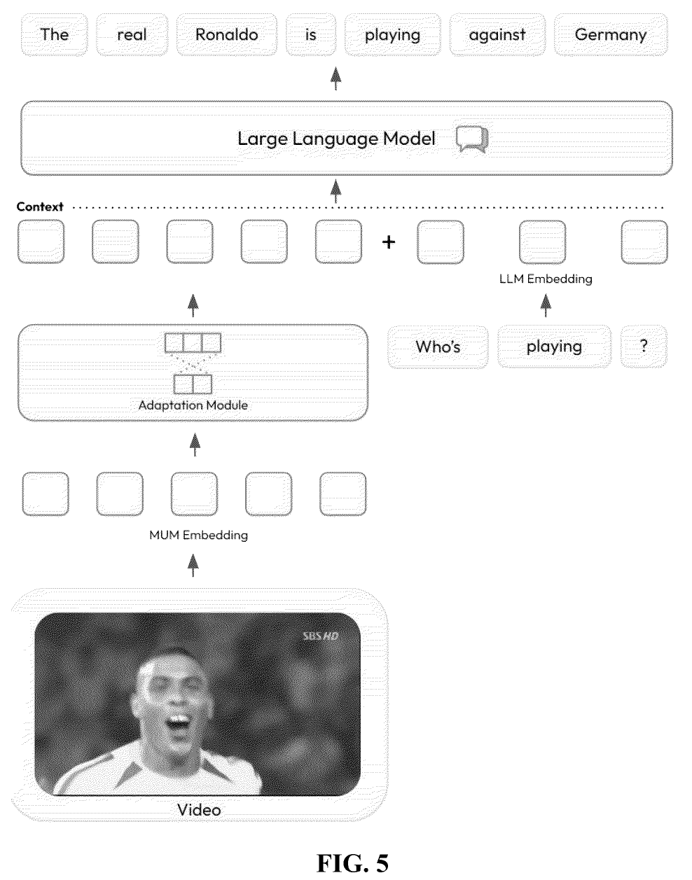

In some embodiments, process 300 can begin in any suitable manner. In some embodiments, process 100 can begin when coordination server 602 receives a request from a user device 616 for analysis of one or more video(s). For example, as shown in FIG. 4, process 100 can begin when a search engine system receives a search query (e.g., in the form of image data, text data, video data, etc.) from a computing device. In another example, process 100 can begin when a video classification system receives a video identifier from a computing device (e.g., a computing device associated with an advertiser). In yet another example, as shown in FIG. 5, process 100 can begin when a chat interface receives a query (e.g., in the form of a textual question) from a computing device in connection with a video being played back on the computing device.

At 110, process 100 can, in some embodiments, receive a content item. Generally speaking, process 100 can receive a content item that includes any suitable combination of image data, video data, audio data, text data, and/or page data. For example, a content item can be a search query that includes text data (e.g., the text inputted in the search query), image data (e.g., one or more images inputted in the search query), video data (e.g., a video link for a video being played back when receiving the search query), audio data (e.g., an audio snippet corresponding to the portion of video being played back when receiving the search query), etc. In another example, process 100 can receive a media file, a video identification label, and/or a storage location corresponding to a media file, where the media file includes image data corresponding to one or more images within the media file, video data corresponding to the media file, audio data corresponding to the media file, textual data corresponding to speech within the media file and metadata associated with the media file, page data associated with a webpage on which the media file is presented, etc. In yet another example, as shown in FIG. 5, process 100 can receive multiple content items, such as a video content item that is being played back on a computing device (e.g., a video of a sporting event) along with a text content item in the form of a query in a chat interface (e.g., “Who is playing now?”).

At 120, process 100 can extract the text data, image data, video data, audio data, and/or page data from the content item. This can include, for example, an audio portion and multiple image frames corresponding to the frames of the video in some embodiments. For example, process 100 can extract the entire audio portion of the video content item for analysis and can extract a particular number of image frames from the video (e.g., a video frame that occurs at every 1 second, every frame of a video uploaded at a frame rate of 30 frames per second, etc.). In another example, process 100 can extract corresponding data portions from a page that a content item is being presented, such as text data (e.g., text content that is associated with the content item, subtitle or caption information that is associated with an audio or video content item, etc.), image data (e.g., image frames corresponding to the frames of a video content item, resolution information associated with one or more images within the content item, etc.), video data (e.g., a snippet of the video content item, resolution information, audio data (e.g., an audio portion contained within a video content item, an audio snippet that corresponds to the beginning of the video content item, an audio snippet that corresponds to an advertisement that is presented within the video content item, etc.), page data (e.g., placement information of the content item on a given page, content type information regarding the content presented on a given page, adjacency information regarding content items that are placed adjacent to the content item on a given page, etc.), and/or any other suitable data from the content item.

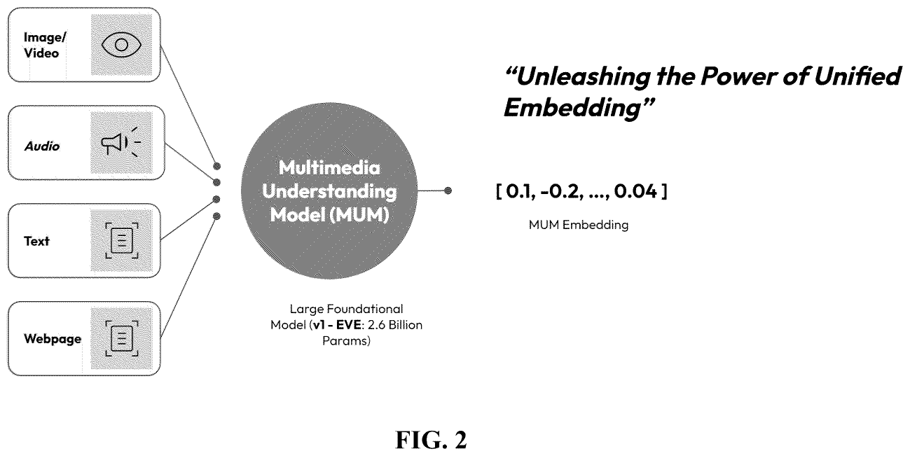

At 130, process 100 can transmit the extracted text data, image data, video data, audio data, page data, and/or any other suitable data extracted from the content item to a multimedia understanding model, which analyzes the content item and the data extracted from the content item to generate a unified embedding at 140. For example, as shown in FIG. 2, image and video data, audio data, text data, and/or webpage data can be extracted from a content item and can be transmitted to a multimedia understanding model, where the multimedia understanding model can analyze each of the image and video data, the audio data, the text data, and/or the webpage data extracted from the content item to determine values for each of 2.6 billion parameters and where the values for the 2.6 billion parameters can be represented in a unified embedding (e.g., a unified embedding of [0.1, −0.2, . . . , 0.04]).

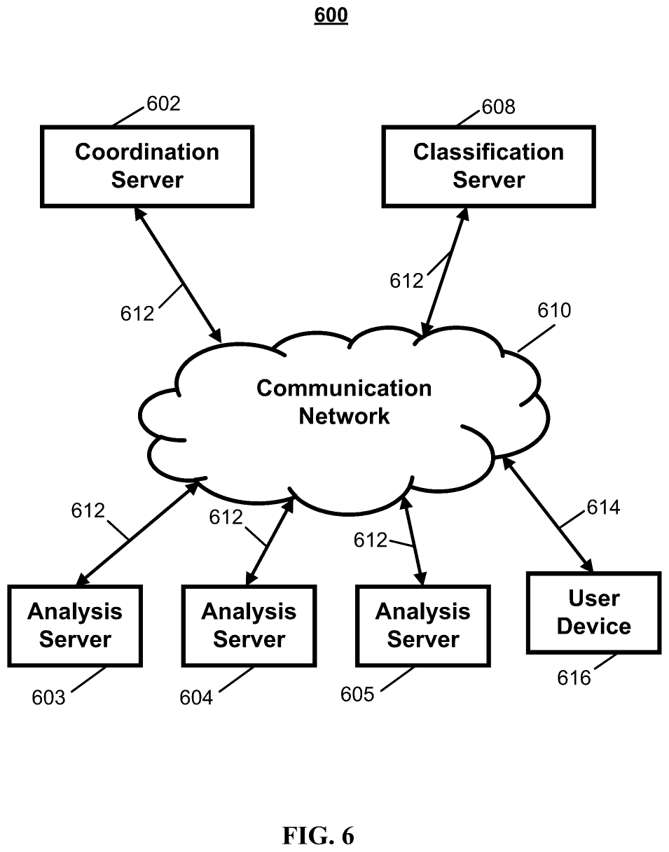

For example, in determining a portion of the 2.6 billion parameters of the unified embedding, the multimedia understanding model can analyze the series of images extracted from a video content item using optical character recognition (OCR), image classification, object detection, and/or any other suitable technique. In a more particular example, in determining a portion of the 2.6 billion parameters of the unified embedding, one of the analysis servers in FIG. 6 can be configured to run and/or train a machine learning model to perform optical character recognition on the extracted image frames, where the images of text within the extracted image frames can be converted into text data and where multiple parameters can be determined from the text data (e.g., extract text and layout information from the image frames, analyze the readability of the text data from the image frame, extract entities from the text data from the image frame, etc.). In continuing this example, in response to inputting a video having multiple image frames into one of the analysis servers for performing automated speech recognition in FIG. 6, the corresponding analysis server can output a transcript of text that appears within the image frames of the video and can be further configured to run and/or train a machine learning model to perform automated speech recognition (ASR). In another more particular example, in determining a portion of the 2.6 billion parameters of the unified embedding, one of the analysis servers in FIG. 6 can be configured to run and/or train a machine learning model to perform an image classification of images appearing within the image frames extracted from the video content item. In yet another more particular example, in determining a portion of the 2.6 billion parameters of the unified embedding, one of the analysis servers in FIG. 6 can be configured to run and/or train a machine learning model to perform object detection on the extracted image frames, where the machine learning model detects objects within the extracted image frames and data regarding the objects detected within the extracted image frames. In continuing this example, the multimedia understanding model can extract multiple image frames from the video content item (e.g., each frame, a frame every five seconds, etc.) and can output a probability, for each image class, as to whether an object appears within the image frame (e.g., “Person 100%,” “Beer 0%,” “Blood 2%,” “Nudity 2%,” etc.).

In another example, in determining a portion of the 2.6 billion parameters of the unified embedding, the multimedia understanding model can analyze the audio track extracted from a video content item using automated speech recognition (ASR), audio tagging, and/or any other suitable technique. In a more particular example, the multimedia understanding model can output a transcript of the audio portion spoken in the video content item. In continuing this example, the multimedia understanding model can be configured to

In some embodiments, each analysis technique used at 140 can be implemented with a machine learning model in connection with the analysis servers in FIG. 6. In some embodiments, any suitable number and/or combination of analysis techniques can be used at 140. In some embodiments, process 100 can use or can abstain from the use of any analysis technique (e.g., OCR) without affecting the results from any other analysis technique (e.g., image classification). For example, the multimedia understanding model can input zeros into the corresponding portions of the unified embedding to inhibit the use of a particular analysis technique.

In some embodiments, at 140, each analysis technique can produce an output as described in connection with the analysis servers in FIG. 6.

At 140, process 100 can combine the results from the audio analysis outputs, the image frame analysis outputs, the text analysis outputs, the video analysis outputs, the page analysis outputs in a unified embedding associated with the content item. For example, in some embodiments, process 100 can write results from each of the analysis servers to the same file and/or location in memory in some embodiments. In some embodiments, process 100 can use any suitable amount of data and/or metadata which is contained in the analysis output from the analysis servers. In some embodiments, process 300 can combine any other suitable information with the results from 140. For example, at 140, process 100 can include a textual description from the metadata of the video and/or any other suitable metadata with the analysis results in some embodiments.

In some embodiments, process 100 can additionally format analysis results from any and/or all of the analysis server in FIG. 6 for use as input to a multimodal machine learning model. For example, in some embodiments, process 100 can perform tokenization and word embedding on ASR transcripts. In another example, in some embodiments, process 100 can perform tokenization and word embedding on OCR transcripts. In another example, in some embodiments, process 100 can perform tokenization and term-frequency inverse-document-frequency (TDIF) weighting on textual description(s) of the video. In another example, in some embodiments, process 100 can submit predictions from the image classifier analysis to a 1-dimensional convolutional layer.

In some embodiments, process 100 can determine a probability that the video contains content from a plurality of categories using the combined and/or formatted analysis results in some embodiments. In some embodiments, process 100 can use the combined and formatted analysis results in any suitable manner. In some embodiments, process 100 can input the combined and formatted analysis results to a trained neural network.

For example, as described above, a multimedia understanding model can receive multiple inputs such as at least one of transcripts or text information from an optical character recognition model that detects text appearing within image frames of the video, transcripts or text information from an automated speech recognition model that detects speech spoken in an audio portion of the video, text based image descriptions generated by social media users, a list of probabilities generated by a pretrained image classifier that images within the image frames of the video fall within particular image classes, a list of audio tags, and/or a list of objects detected in the image frames of the video. In continuing this example, the multimedia understanding model can process OCR transcripts using tokenization and word embedding. Additionally, in some embodiments, the multimedia understanding model can process ASR transcripts using tokenization and word embedding. Additionally, in some embodiments, the multimedia understanding model can process any other suitable text using tokenization and term-frequency inverse-document-frequency weighting. For example, video descriptions can be processed by tokenization and term-frequency inverse-document-frequency (TFIDF) weighting, where the TFIDF values can then be submitted to a fully connected layer. In some embodiments, the multimedia understanding model can process image classifier predictions in a one-dimensional convolutional layer. For example, image classifier predictions can be padded to a standard length, and then submitted to a one-dimensional convolutional layer. Across all image predictions, the multimedia understanding model can then select the maximum value of each dimension of the convolutional output.

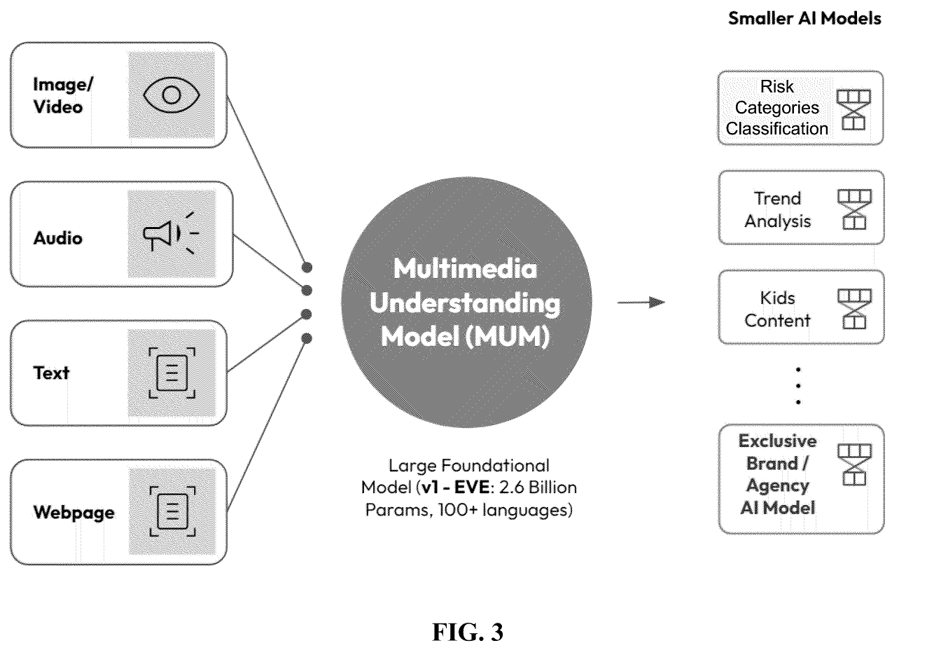

In some embodiments, at 150, process 100 can generate, train, update, and/or modify multiple machine learning models and/or applications using the unified embedding received from the multimedia understanding model. For example, as shown in FIG. 3, the multimedia understanding model can transmit the unified embedding to one or more machine learning models (e.g., a classification server executing a classification model that classifies the content of the content item, such as a video content item, into specifically defined risk categories) and/or applications (e.g., an application that generates groups of content items that represent daily trends, a search engine application that provides matching content items based on text inputs, image inputs, audio inputs, video inputs, etc., a classification application that generates new or additional categories for classifying the content of a content item, etc.).

For example, in continuing the above-mentioned example, the classification head of the multimedia understanding model can begin by concatenating the final outputs of the ASR, OCR, description, and image classifier components. The output of this concatenation can then be successively processed by several alternating dropout and fully connected layers. A final fully connected classification layer can then compute the probability of the input video containing each binary risk category.

In some embodiments, process 100 can train a neural network with a set of training data labeled with categories from the plurality of categories. In some embodiments, process 100 can run a trained neural network with alternating dropout and fully connected layers. In some embodiments, the neural network can include a fully connected classification layer at 310.

In some embodiments, the trained neural network can use the unified embedding to output a probability for each category in the plurality of categories. For example, in some embodiments, process 100 can output a set of twelve values [0.28, 0.01, 0.05, 0.00, 0.00, 0.33, 0.66, 0.70, 0.10, 0.05, 0.13, 0.66], where each value can correspond to the probability that a video content item is classified in the corresponding twelve categories in a framework for responsible brand safety (listed below):
1. Adult and Explicit Sexual Content
2. Arms and Ammunition
3. Crime and Harmful Acts to Individuals and Society and Human Right Violations
4. Death, Injury, or Military Conflict
5. Online Piracy
6. Hate Speech and Acts of Aggression
7. Obscenity and Profanity
8. Illegal Drugs, Tobacco, eCigarettes, Vaping, and Alcohol
9. Spam or Harmful Content
10. Terrorism
11. Debated Sensitive Social Issues
12. Misinformation

In some embodiments, process 100 can determine a threshold probability for each category in the plurality of categories. In some embodiments, process 100 can determine a threshold probability using any suitable mechanism. In some embodiments, process 100 can use a subset of training data which was reserved from training the neural network (e.g., “holdout data”). In some embodiments, process 100 can use a machine learning model, statistical model (e.g., F-score), and/or any suitable mathematical function to determine threshold probabilities. In some embodiments, process 100 can determine a different threshold for each category in the plurality of categories.

In continuing this example, process 100 can, for each category, compare the determined probabilities to the determined threshold values. For example, process 100 can assign a positive binary indicator to a probability that is equal to or above the threshold value (e.g., “yes” or “1”). Similarly, in some embodiments, process 100 can assign a negative binary indicator (e.g., “no” or “0”) to a probability that is less than the threshold value.

In some embodiments, process 100 can associate any category with a positive indicator with the content item. In some embodiments, process 100 can associate any number of categories from the plurality of categories with the content item. In some embodiments, process 100 can associate the categories to the content item in any suitable manner. For example, process 100 can add the positive indicated categories to the metadata of the content item.

For example, an advertiser can receive categories associated with a positive indicator to determine whether a particular video meets safety requirements. In continuing this example, the advertiser can determine whether to place an advertisement in connection with the video (e.g., a pre-roll advertisement, a mid-roll advertisement, or a post-roll advertisement).

In another example, an advertiser can receive categories associated with a positive indicator to determine how many advertisements have been placed with a content item (e.g., a video content item) that is deemed to be unsafe or otherwise unsuitable for a brand associated with the advertiser.

Additionally or alternative to determining categories corresponding to the content item based on the associated unified embedding, the multimedia understanding model can determine new or additional categories for classifying the content of a content item. For example, based on unified embeddings associated with content items that an advertiser deems as desirable for placing advertising content items that are within or adjacent to the content items, a content classifier model can determine new content categories for a campaign of advertising content items corresponding to the desired content items. In another example, based on unified embeddings associated with content items that an advertiser deems as desirable for placing advertising content items that are within or adjacent to the content items, a content classifier model can suggest additional content categories for associated with a campaign of advertising content items.

The multimedia understanding model and the unified embeddings generated using the multimedia understanding model can be used in any suitable application.

For example, turning to FIG. 4, a search query can be received, where the search query can include image data, text data, video data, audio data, page data, etc. In a more particular example, a search query can include (i) one or more images extracted from a video, one or more images received from a user having an imaging device, and/or one or more images selected from a collection of images; (ii) one or more words inputted by a user, text data extracted from a received image or video, and/or subtitle data extracted from the audio portion of a received video; (iii) audio data extracted from a received video, a portion of audio data that corresponds to a particular portion of the received video, and/or background music or song data extracted from a received video; and/or (iv) data associated with a page on which the search query was received, and/or link information associated with a page mentioned in the search query. The extracted image data, text data, video data, audio data, and/or page data can be inputted into the multimedia understanding model, which can generate a unified embedding corresponding to the search query and the content components associated with the search query. In response to generating the unified embedding corresponding to the search query and the content components associated with the search query, the unified embedding can be applied to a vector database that includes vectors corresponding to content items, such as video content items, image content items, audio content items, links to pages, textual content items, etc., where each of the content items is mapped into an embedding space. A deep learning neural network corresponding to the search engine application can determine a region or a vector within an embedding space that corresponds with the unified embedding. For example, the deep learning neural network corresponding to the search engine application can determine a similarity (e.g., cosine similarity) between the unified embedding corresponding to the search query (e.g., a unified embedding of [0.53, 0.77, 0.11, . . . ]) and the embeddings corresponding to the content items within the vector database. The matching content items (e.g., one or more video content items, one or more pages, one or more audio content items, one or more image content items, one or more textual content items, etc.) can be presented as search results that are responsive to the search query.

It should be noted that, in addition to providing inputs having multiple content types to the multimedia understanding model (e.g., image, video, audio, text, page, etc.), the search results outputted by the multimodal search engine can have multiple content types (e.g., images, videos, audio files, text files, pages, etc.).

In continuing this example, in some embodiments, the search engine application can be used to search through customer inventory of content items to determine matching content items for the placement of advertising content items associated with an advertiser (as shown in FIGS. 3 and 4). Additionally or alternatively, the search engine application can be used to determine whether the content items in which advertising content items are placed by an advertiser have unified embeddings that match a target unified embedding.

In another example, as shown in FIG. 3, the multimedia understanding model and the unified embeddings generated using the multimedia understanding model can be used to generate groups of content items representing trend information (e.g., daily trends). In a more particular example, content items relating to trend information (e.g., popular videos for a given day) and their corresponding content components extracted from the content items can be inputted into the multimedia understanding model to determine matching content items having unified embeddings that match the unified embedding corresponding to the trend information.

In yet another example, as shown in FIG. 3, the multimedia understanding model and the unified embeddings generated using the multimedia understanding model can be used to determine whether a content item contains content components that are safe for children (e.g., kids content). In a more particular example, the multimedia understanding model can transmit the unified embedding corresponding to a content item to a classification model that classifies the content of the content item into each of twelve specifically defined risk categories, where the classification of the content item into each of the twelve specifically defined risk categories can determine whether the content item is deemed safe for consumption by a child.

In a further example, as shown in FIG. 5, the multimedia understanding model can be used in connection with a large language model or any other suitable models. As shown, a chatbot interface can receive a query in connection with a content item that is currently being played back—e.g., the query “Who's playing?” can be received from a user in a chatbot interface (e.g., a text input, a voice input, etc.) while a video is currently being played back to a user. In response to receiving the query in the chatbot interface while the content item is currently being presented to the user, the components of the content item that can include text data, image data, video data, audio data, and/or page data can be extracted and transmitted to the multimedia understanding model, where the multimedia understanding model can generate a unified embedding that corresponds to the extracted components of the content item. The unified embedding can be transmitted to an adaptation module that determines contextual information corresponding to different portions (e.g., image frames) of the content item. In addition, the components of the query can be extracted and transmitted to the multimedia understanding model or any other suitable model to determine a language embedding corresponding to the query. The contextual information corresponding to the content item and the language embedding corresponding to the query can be transmitted to a large language model that determines an answer to the query based on the contextual information within the content item when the query was received. For example, as shown in FIG. 5, in response to the query “Who's playing?” that is received at a particular portion of a video content item, the large language model can provide a predicted answer to the query as an output—e.g., “The real Ronaldo is playing against Germany.”

Turning to FIG. 6, an illustrative example of a system 600 for generating custom models using a multimedia understanding model in accordance with some embodiments is shown. As illustrated, system 600 can include a coordination server 602, analysis servers 603, 604, and 605, a classification server 608, a communication network 610, and one or more user devices 616.

Coordination server 602 can be any suitable server(s) for storing information, data, programs, media content, and/or any other suitable content. In some embodiments, server 602 can perform any suitable function(s). In some embodiments, coordination server 602 can send and receive messages using communication network 610. For example, in some embodiments, coordination server 602 can combine analysis outputs from analysis servers 603, 604, and 605 and/or any other suitable analysis servers into a combined analysis record associated with an input video for transmission to classification server 608. In a more particular example, in response to inputting a video having multiple image frames into analysis server 604 for performing automated speech recognition, analysis server 604 for performing automated speech recognition, and analysis server 605 for performing image classification, coordination server 602 can combine the outputs from each analysis server into a unified embedding and transmit the unified embedding and/or any other suitable combined analysis information to a multimodal neural network executing on classification server 608 for classifying the content of the video into each of twelve specifically defined risk categories and for indication which risk categories that the video may be deemed unsafe for providing content, such as an advertisement.

Analysis servers 603, 604, and 605 can be any suitable servers for storing information, data, programs, media content, and/or any other suitable content. In some embodiments, analysis servers 603, 604, and 605 can send and receive messages using communication network 610.

In some embodiments, analysis servers 603, 604, and 605 can each be configured to run and/or train a machine learning model (e.g., neural networks, decision trees, classification techniques, Bayesian statistics, and/or any other suitable technique) to perform image and/or audio analysis techniques.

For example, in some embodiments, analysis server 603 can be configured to run and/or train a machine learning model to perform optical character recognition (OCR). In this example, in some embodiments, analysis server 603 can train a machine learning model on a dataset such as images from social media which contain metadata and/or text overlaid on video frames. Continuing this example, in some embodiments, analysis server 603 can additionally run a trained machine learning model to output a transcript of metadata and/or text overlaid on a video frame when given a video outside of the training dataset as input. For example, in response to inputting a video having multiple image frames into analysis server 603 for performing automated speech recognition, analysis server 603 can output a transcript of text that appears within the image frames of the video.

In another example, in some embodiments, analysis server 604 can be configured to run and/or train a machine learning model to perform automated speech recognition (ASR). In this example, in some embodiments, analysis server 604 can train a machine learning model on a dataset containing speech in any suitable language. Continuing this example, in some embodiments, analysis server 604 can additionally run a trained machine learning model to output a transcript of an audio record when given a video and/or audio track outside of the training dataset as an input. In another example, in some embodiments, analysis server 604 can be configured to run and/or train a machine learning model to tag an audio track. In this example, in some embodiments, analysis server 604 can train a machine learning model to recognize sounds relevant for advertising brand safety (e.g., explosions, gunshots). Continuing this example, in some embodiments, analysis server 604 can additionally run a trained machine learning model to output a record of audio tags identified in an audio track when given a video and/or audio track outside of the training dataset as input. For example, in response to inputting a video having multiple image frames and an audio portion into analysis server 604 for performing automated speech recognition, analysis server 604 can output a transcript of the audio portion spoken in each of the image frames of the video.

In another example, in some embodiments, analysis server 605 can be configured to run and/or train a machine learning model to perform image classification. In this example, in some embodiments, analysis server 605 can train a machine learning model to classify images across any suitable number of categories. In particular, in some embodiments, analysis server 605 can train a machine learning model to classify images across 600 or more categories relevant for advertising brand safety (e.g., alcohol, drugs, nudity, extremist symbols). In some embodiments, given an image input to a trained machine learning model, analysis server 605 can output a probability for each category corresponding to the likelihood that the input image can be classified into each of the categories used to train the machine learning model. For example, in response to inputting a video having multiple image frames into analysis server 605 for performing image classification, analysis server 605 can extract multiple frames from the video (e.g., each frame, a frame every five seconds, etc.) and output a probability, for each image class, as to whether an object appears within the image frame (e.g., “Person 100%,” “Beer 0%,” “Blood 2%,” “Nudity 2%,” etc.). It should be noted that, as shown in FIG. 6B, the image classes having a higher probability can be ranked at the top of the list of image class probabilities for the video.

In another example, in some embodiments, analysis server 605 (or any other suitable analysis server) can be configured to run and/or train a machine learning model to perform object detection. In this example, in some embodiments, analysis server 605 can train a machine learning model to detect objects within an image. Continuing this example, in some embodiments, analysis server 605 can additionally run a trained machine learning model to output a record of objects detected when given an image outside of the training dataset as input.

It should be noted that, although the embodiments described herein include analysis server 603 for performing optical character recognition, analysis server 604 for performing automated speech recognition, and analysis server 605 for image classification, this is merely illustrative and any suitable number of analysis servers can be used. For example, a single analysis server can, in parallel, perform optical character recognition of text appearing in a video, automated speech recognition to detect words being spoken in the video, and image classification to detect objects appearing in the video. In another example, an analysis server can perform analyses on the image frames of the video, such as optical character recognition and image classification, and another analysis server can perform analyses on the audio portion of the video, such as automated speech recognition and audio tagging. In yet another example, additional analysis servers or additional models can be incorporated into system 600, such as an analysis server for audio tagging that recognizes sounds occurring in the video (e.g., explosions or gunshots).

Classification server 608 can be any suitable server for storing information, data, programs, media content, and/or any other suitable content in some embodiments. In some embodiments, classification server 608 can send and receive messages using communication network 610. For example, in some embodiments, classification server 608 can receive analysis results from coordination server 602 through communication links 612.

In some embodiments, classification server 608 can run and/or train a multimodal classification machine learning model. For example, classification server 608 can include a combination of convolutional neural networks and text vectorizers. In a more particular example, the multimodal classifier can be a neural network that receives multiple inputs such as at least one of transcripts or text information from an optical character recognition model that detects text appearing within image frames of the video, transcripts or text information from an automated speech recognition model that detects speech spoken in an audio portion of the video, text based image descriptions generated by social media users, a list of probabilities generated by a pretrained image classifier that images within the image frames of the video fall within particular image classes, a list of audio tags, and/or a list of objects detected in the image frames of the video. In continuing this example, the neural network can process OCR transcripts using tokenization and word embedding. Additionally, in some embodiments, the neural network can process ASR transcripts using tokenization and word embedding. Additionally, in some embodiments, the neural network can process any other suitable text using tokenization and term-frequency inverse-document-frequency weighting. For example, video descriptions can be processed by tokenization and term-frequency inverse-document-frequency (TFIDF) weighting, where the TFIDF values can then be submitted to a fully connected layer. In some embodiments, classification server 608 can process image classifier predictions in a one-dimensional convolutional layer. For example, image classifier predictions can be padded to a standard length, and then submitted to a one-dimensional convolutional layer. Across all image predictions, the multimodal neural network can then select the maximum value of each dimension of the convolutional output.

In continuing this example, the classification head of the multimodal neural network begins by concatenating the final outputs of the ASR, OCR, description, and image classifier components. The output of this concatenation can then be successively processed by several alternating dropout and fully connected layers. A final fully connected classification layer can then compute the probability of the input video containing each binary category of potential risk.

In some embodiments, classification server 608 can store and/or access training data for use with the multimodal classification machine learning model. In some embodiments, the training data can include media content item(s) with audio track(s), video track(s), video description(s), text overlay on video frame(s), and/or any other suitable features. In some embodiments, the training data can include labels indicating a category, classification and/or any other suitable identifier to the audio track, video track, video description, text overlay, and/or any other suitable media content feature. In some embodiments, classification server 608 can use any suitable amount of training data to train the multimodal classification machine learning model. In some embodiments, classification server 608 can use a portion of available data to train the multimodal classification machine learning model.

Communication network 610 can be any suitable combination of one or more wired and/or wireless networks in some embodiments. For example, in some embodiments, communication network can include any one or more of the Internet, an intranet, a wide-area network (WAN), a local-area network (LAN), a wireless network, a digital subscriber line (DSL) network, a frame relay network, an asynchronous transfer mode (ATM) network, a virtual private network (VPN), and/or any other suitable communication network. In some embodiments, user devices 616 can be connected by one or more communications links (e.g., communications links 614) to communication network 610 that can be linked via one or more communications links (e.g., communications links 612) to coordination server 602. The communications links can, in some embodiments, be any communications links suitable for communicating data among user devices 616 and coordination server 602 such as network links, dial-up links, wireless links, hard-wired links, any other suitable communications links, or any suitable combination of such links.

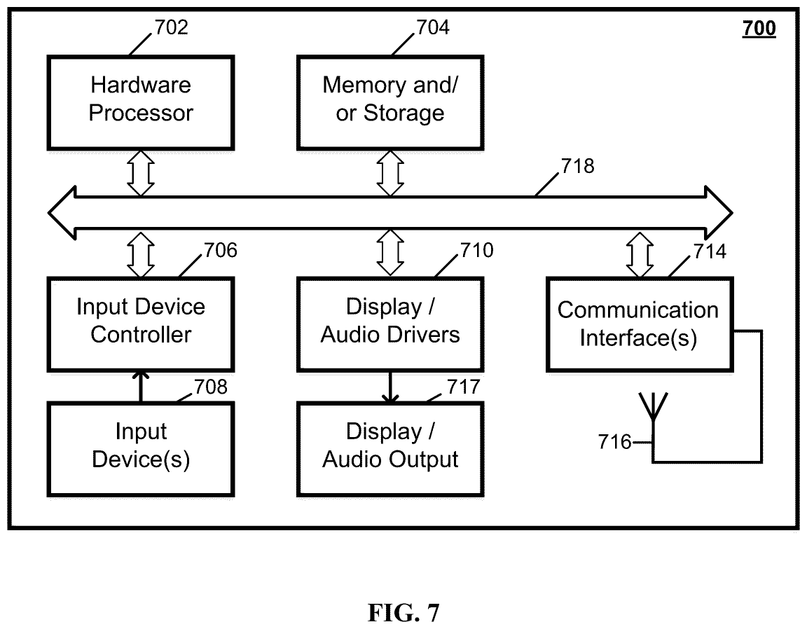

Servers 602, 603, 604, 605, and 608 can be implemented using any suitable hardware in some embodiments. For example, in some embodiments, coordination server 602 can be implemented using any suitable general-purpose computer or special-purpose computer and can include any suitable hardware. For example, in some embodiments, as illustrated in example hardware 700 of FIG. 7, such hardware can include hardware processor 702, memory and/or storage 404, an input device controller 706, an input device 708, display/audio drivers 710, display and audio output circuitry 712, communication interface(s) 714, an antenna 716, and a bus 718.

Hardware processor 702 can include any suitable hardware processor, such as a microprocessor, a micro-controller, digital signal processor(s), dedicated logic, and/or any other suitable circuitry for controlling the functioning of a general-purpose computer or a special-purpose computer in some embodiments. In some embodiments, hardware processor 702 can be controlled by a computer program stored in memory and/or storage 704. For example, in some embodiments, the computer program can cause hardware processor 702 to perform functions described herein.

Memory and/or storage 704 can be any suitable memory and/or storage for storing programs, data, documents, and/or any other suitable information in some embodiments. For example, memory and/or storage 704 can include random access memory, read-only memory, flash memory, hard disk storage, optical media, and/or any other suitable memory in some embodiments.

Input device controller 706 can be any suitable circuitry for controlling and receiving input from one or more input devices 708 in some embodiments. For example, input device controller 706 can be circuitry for receiving input from a touchscreen, from a keyboard, from a mouse, from one or more buttons, from a voice recognition circuit, from a microphone, from a camera, from an optical sensor, from an accelerometer, from a temperature sensor, from a near field sensor, and/or any other type of input device in some embodiments.

Display/audio drivers 710 can be any suitable circuitry for controlling and driving output to one or more display/audio output devices 712 in some embodiments. For example, display/audio drivers 710 can be circuitry for driving a touchscreen, a flat-panel display, a cathode ray tube display, a projector, a speaker or speakers, and/or any other suitable display and/or presentation devices in some embodiments.

Communication interface(s) 714 can, in some embodiments, be any suitable circuitry for interfacing with one or more communication networks, such as network 612 as shown in FIG. 6. For example, interface(s) 714 can include network interface card circuitry, wireless communication circuitry, and/or any other suitable type of communication network circuitry in some embodiments.

Antenna 716 can be any suitable one or more antennas for wirelessly communicating with a communication network (e.g., communication network 612) in some embodiments. In some embodiments, antenna 716 can be omitted.

Bus 718 can be any suitable mechanism for communicating between two or more components 702, 704, 706, 710, and 714 in some embodiments.

Any other suitable components can be included in hardware 700 in accordance with some embodiments.

In some embodiments, at least some of the above described blocks of the processes of FIGS. 1-5 can be executed or performed in any order or sequence not limited to the order and sequence shown in and described in connection with the figures. Also, some of the above blocks of FIGS. 1-5 can be executed or performed substantially simultaneously where appropriate or in parallel to reduce latency and processing times. Additionally or alternatively, some of the above described blocks of the processes of FIGS. 1-5 can be omitted.

In some embodiments, any suitable computer readable media can be used for storing instructions for performing the functions and/or processes described herein. For example, in some embodiments, computer readable media can be transitory or non-transitory. For example, non-transitory computer readable media can include media such as non-transitory forms of magnetic media (such as hard disks, floppy disks, etc.), non-transitory forms of optical media (such as compact discs, digital video discs, Blu-ray discs, etc.), non-transitory forms of semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Accordingly, methods, systems, and media for generating one or more custom models, such as artificial intelligence models or machine learning models, using a multimedia understanding model are provided.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A method for generating custom models, the method comprising:
receiving, from a computing device, a content item that contains at least one of text data, image data, video data, audio data, and page data;
extracting the text data, the image data, the video data, the audio data, and the page data from the content item;
inputting the text data, the image data, the video data, the audio data, and the page data from the content item extracted from the content item into a multimedia understanding model that has been trained from a plurality of content items each having at least one of text data, image data, video data, audio data, and page data, wherein the multimedia understanding model generates a unified embedding having a plurality of values that each represent a component of the text data, the image data, the video data, the audio data, and the page data associated with the content item; and
applying the unified embedding to one of a plurality of machine learning models.

2. The method of claim 1, wherein the unified embedding further comprises a plurality of first values that each correspond to portions of the text data, a plurality of second values that each correspond to portions of the image data, a plurality of third values that each correspond to portions of the video data, a plurality of fourth values that each correspond to portions of the audio data, and a plurality of fifth values that each correspond to portions of the page data.

3. The method of claim 1, wherein the content item is trend data associated with a particular time period and wherein the unified embedding associated with the trend data is applied to a classification learning model that generates groups of content items that each include a plurality of content items having an embedding that is similar to the unified embedding corresponding to the trend data.

4. The method of claim 1, wherein the content item is a search query and wherein the unified embedding associated with the search query is applied to a search engine application that generates one or more search query results of content items having an embedding within a vector database that is similar to the unified embedding corresponding to the search query.

5. The method of claim 4, wherein the one or more search query results comprise one of: a matching video content item, a matching image content item, a matching audio content item, a matching textual content item, and a matching page content item.

6. The method of claim 1, the unified embedding associated with the content item is applied to a classification learning model that determines whether to generate a new category for classifying content items.

7. The method of claim 6, the new category is added to a plurality of existing risk categories.

8. The method of claim 1, the unified embedding associated with the content item is applied to an adaptation model that determines contextual information associated with the content item, wherein the contextual information associated with the content item and a large language model embedding generated based on received textual inquiry submitted to a chatbot application are inputted into a large language model to determine a response to the received textual inquiry.

9. A system for generating custom models, the system comprising:
a server that includes a hardware processor, wherein the hardware processor is configured to:
receive, from a computing device, a content item that contains at least one of text data, image data, video data, audio data, and page data;
extract the text data, the image data, the video data, the audio data, and the page data from the content item;
input the text data, the image data, the video data, the audio data, and the page data from the content item extracted from the content item into a multimedia understanding model that has been trained from a plurality of content items each having at least one of text data, image data, video data, audio data, and page data, wherein the multimedia understanding model generates a unified embedding having a plurality of values that each represent a component of the text data, the image data, the video data, the audio data, and the page data associated with the content item; and
apply the unified embedding to one of a plurality of machine learning models.

10. The system of claim 9, wherein the unified embedding further comprises a plurality of first values that each correspond to portions of the text data, a plurality of second values that each correspond to portions of the image data, a plurality of third values that each correspond to portions of the video data, a plurality of fourth values that each correspond to portions of the audio data, and a plurality of fifth values that each correspond to portions of the page data.

11. The system of claim 9, wherein the content item is trend data associated with a particular time period and the unified embedding associated with the trend data is applied to a classification learning model that generates groups of content items that each include a plurality of content items having an embedding that is similar to the unified embedding corresponding to the trend data.

12. The system of claim 9, wherein the content item is a search query and the unified embedding associated with the search query is applied to a search engine application that generates one or more search query results of content items having an embedding within a vector database that is similar to the unified embedding corresponding to the search query.

13. The system of claim 12, wherein the one or more search query results comprise one of: a matching video content item, a matching image content item, a matching audio content item, a matching textual content item, and a matching page content item.

14. The system of claim 9, wherein the unified embedding associated with the content item is applied to a classification learning model that determines whether to generate a new category for classifying content items.

15. The system of claim 14, wherein the new category is added to a plurality of existing risk categories.

16. The system of claim 9, wherein the unified embedding associated with the content item is applied to an adaptation model that determines contextual information associated with the content item, wherein the contextual information associated with the content item and a large language model embedding generated based on received textual inquiry submitted to a chatbot application are inputted into a large language model to determine a response to the received textual inquiry.

17. A non-transitory computer-readable medium containing computer executable instructions that, when executed by a processor, cause the processor to perform a method for generating custom models, the method comprising:
receiving, from a computing device, a content item that contains at least one of text data, image data, video data, audio data, and page data;
extracting the text data, the image data, the video data, the audio data, and the page data from the content item;
inputting the text data, the image data, the video data, the audio data, and the page data from the content item extracted from the content item into a multimedia understanding model that has been trained from a plurality of content items each having at least one of text data, image data, video data, audio data, and page data, wherein the multimedia understanding model generates a unified embedding having a plurality of values that each represent a component of the text data, the image data, the video data, the audio data, and the page data associated with the content item; and
applying the unified embedding to one of a plurality of machine learning models.
